(19) United States
(12) Patent Application Publication
(10) Pub. No.: US 2023/0178730 A1
(43) Pub. Date: Jun. 8, 2023

(54) POSITIVE ELECTRODE ACTIVE MATERIAL FOR LITHIUM-RICH SECONDARY BATTERY AND METHOD FOR MANUFACTURING THE SAME

(71) Applicant: UIF (University Industry Foundation), Yonsei University, Seoul (KR)

(72) Inventors: Seong-Ju HWANG, Seoul (KR); Tae-Ha GU, Seoul (KR)

(73) Assignee: UIF (University Industry Foundation), Yonsei University, Seoul (KR)

(21) Appl. No.: 18/073,317

(22) Filed: Dec. 1, 2022

(30) Foreign Application Priority Data
Dec. 2, 2021 (KR) 10-2021-0170653

(51) Int. Cl. H01M 4/58; H01M 4/505; H01M 4/525; H01M 10/052

(52) U.S. Cl. CPC H01M 4/5815; H01M 4/505; H01M 4/525; H01M 10/052; H01M 2004/028

(57) ABSTRACT

The present invention provides a lithium-rich secondary battery having high-capacity/high-stability, which can stabilize an irreversible extraction reaction of oxygen in which the oxygen is excessively oxidized between initial charge and discharge to become a gas, while simultaneously preventing deterioration in structural stability without requiring additional chemical composition control or heterogeneous element substitution, and a manufacturing method thereof.

### TECHNICAL FIELD

The present invention relates to a positive electrode active material for a lithium-rich secondary battery, and a method for manufacturing the same.

### BACKGROUND ART

As technology development and demand for mobile devices increase, demand for secondary batteries as an energy source is rapidly increasing. Among such secondary batteries, a lithium secondary battery exhibiting relatively high energy density and operating potential and having long cycle life and low self-discharge rate has been commercialized and widely used. In addition, as interest in environmental issues has recently increased, many researches on the lithium secondary battery as a power source for electric/hybrid vehicles are being conducted, wherein the electric/hybrid vehicles can replace fossil fuel-using vehicles such as gasoline vehicles and diesel vehicles, which are one of the main causes of air pollution.

However, the lithium secondary batteries currently commercialized or under study have limitations in being used as a power source for the aforementioned electric vehicles or hybrid vehicles, because they have the following problems:

First, since the positive electrode materials for secondary batteries introduced so far generally exhibit a discharge specific capacity of less than 200 mAh/g, there is a problem in implementing sufficient mileage and stable driving as a power source for the electric/hybrid vehicles. More specifically, the lithium secondary batteries have excellent life characteristics and charging/discharging efficiency, but a limitation of reversible capacity due to the thermodynamic limit of the lithium secondary battery, a problem of relatively poor structural stability, a problem of extremely low price competitiveness due to resource limitations of raw materials used in the positive electrode active materials, and the like, so there are limitations in their use as a power source in fields such as the electric/hybrid vehicles.

Second, although a lithium-rich secondary battery having a high energy density has been introduced to overcome the above-mentioned limitation of reversible capacity, the lithium-rich secondary battery causes an irreversible extraction reaction of oxygen in which the oxygen is excessively oxidized between initial charge and discharge to become a gas, whereby the structure of the active material is collapsed or a voltage drop phenomenon occurs accordingly, resulting in a problem of accelerating deterioration of the secondary battery structure. In addition, electrical/chemical problems such as increased resistance and generation of gas due to electrolyte decomposition caused by high voltage driving have been reported.

Third, in order to solve the above-mentioned electrical/chemical problems of lithium-rich secondary batteries and fully utilize the lithium-rich secondary batteries having high energy density, studies on the control of chemical composition or the substitution of heterogeneous elements have been introduced, but research for minimizing the irreversible reaction of oxygen in the lithium-rich secondary battery while simultaneously improving its structural stability has not yet been introduced.

Therefore, in order to fully utilize the lithium-rich secondary battery capable of exhibiting a high usable capacity of 200 mAh/g or more, there is an urgent need for research on the lithium-rich secondary batteries which can stabilize the irreversible extraction reaction of oxygen in which the oxygen is excessively oxidized between initial charge and discharge to become a gas, while simultaneously preventing deterioration in the structural stability without additionally requiring the chemical composition control or the heterogeneous element substitution.

### PRIOR ART LITERATURE

### Patent Documents

(Patent Document 1) Korean Patent Laid-Open Publication No. 2011-0097719 (published on Oct. 15, 2012)

### DISCLOSURE

### Technical Problem

It is an object of the present invention to provide a lithium-rich secondary battery having high-capacity/high-stability, which can stabilize an irreversible extraction reaction of oxygen in which the oxygen is excessively oxidized between initial charge and discharge to become a gas, while simultaneously preventing deterioration in structural stability without requiring additional chemical composition control or heterogeneous element substitution, and a manufacturing method thereof.

### Technical Solution

In order to achieve the above object, the present invention provides a positive electrode active material for a lithium-rich secondary battery, wherein the active material has a surface modified with sulfate and thus having a sulfur (S) content of 0.3 to 1.0% by weight.

According to one embodiment of the present invention, the positive electrode active material may not further include an additional layer.

In addition, the positive electrode active material is represented by the following chemical formula (1):

LiₐNi_{b}Mn_{c}O_{d}S (1)

wherein a is 1.2 to 1.8, b is 0.2 to 0.3, c is 0.5 to 1.5, and d is 2 to 3.

Further, the positive electrode active material satisfies both the following relational equations (1) and (2):

Mn³⁺/Me=1.0 to 2.2; and (1)

Ni²⁺/Ni³⁺=0.8 to 2.4. (2)

Further, the sulfur (S) may be derived from thiourea (NH₂CSNH₂).

Further, the positive electrode active material may have a charge/discharge capacity of 220 mAhg⁻¹ or more at a voltage of 4.8 V and a current density of 20 mAhg⁻¹.

In addition, the present invention provides a method of manufacturing a positive electrode active material for a lithium-rich secondary battery, wherein the method includes a step of preparing a positive electrode active material comprising lithium manganese nickel oxide (LMNO) whose surface is modified with a sulfur precursor to form sulfate on the surface, wherein the content of sulfur (S) in the positive electrode active material is 0.3 to 1.0 weight (volume) %.

According to one embodiment of the present invention, the sulfur precursor may be thiourea (NH₂CSNH₂).

Further, the lithium manganese nickel oxide (LMNO) and the sulfur precursor may react in a weight ratio of 1:0.2 to 2.0.

In addition, the present invention provides a lithium secondary battery including the positive electrode active material described above.

### Advantageous Effects

According to the present invention, it is possible to manufacture a lithium-rich secondary battery having high-capacity/high-stability, which can stabilize an irreversible extraction reaction of oxygen, in which the oxygen is excessively oxidized between initial charge and discharge to become a gas, by weakening a transition metal-oxygen covalent bond to induce a reversible redox reaction of oxygen, while simultaneously preventing deterioration in structural stability without requiring additional chemical composition control or heterogeneous element substitution.

### DESCRIPTION OF DRAWINGS

FIG. 1 is a graph showing measurement results of extended X-ray absorption fine structure (EXAFS) and X-ray absorption near edge structure (XANES) for Examples and Comparative Examples according to the present invention. In the figure, Example 1 is designated as LMS10, Example 2 as LMS 5, Example 3 as LMS 15, and Comparative Example 1 as LM, respectively.

FIG. 2 is a graph showing measurement results of powder X-ray diffraction (XRD) for Examples and Comparative Examples according to the present invention.

FIG. 3 is an SEM image for Examples and Comparative Examples according to the present invention.

FIG. 4 is a graph showing the results of XPS analysis for Examples and Comparative Examples according to the present invention.

FIG. 5 is a graph showing electrode activity results of lithium-rich secondary batteries prepared in Examples and Comparative Examples according to the present invention.

### BEST MODES OF THE INVENTION

Hereinafter, embodiments of the present invention will be described in detail so as to be easily implemented by one of ordinary skill in the art to which the present invention pertains. The present invention may be embodied in a variety of forms and is not be limited to the embodiments described herein.

As described above, the conventional lithium secondary batteries and lithium-rich secondary batteries have limitations in their utilization due to the limitation of reversible capacity caused by the thermodynamic limit, the problem of poor structural stability, and the like.

Accordingly, the present invention is to solve the above problems by providing a positive electrode active material for a lithium-rich secondary battery, wherein the active material has a surface modified with sulfate and thus having a sulfur (S) content of 0.3 to 1.0% by weight.

Accordingly, it is possible to manufacture a lithium-rich secondary battery having high-capacity/high-stability, which can stabilize an irreversible extraction reaction of oxygen, in which the oxygen is excessively oxidized between initial charge and discharge to become a gas, by weakening a transition metal-oxygen covalent bond to induce a reversible redox reaction of oxygen, while simultaneously preventing deterioration in structural stability without requiring additional chemical composition control or heterogeneous element substitution.

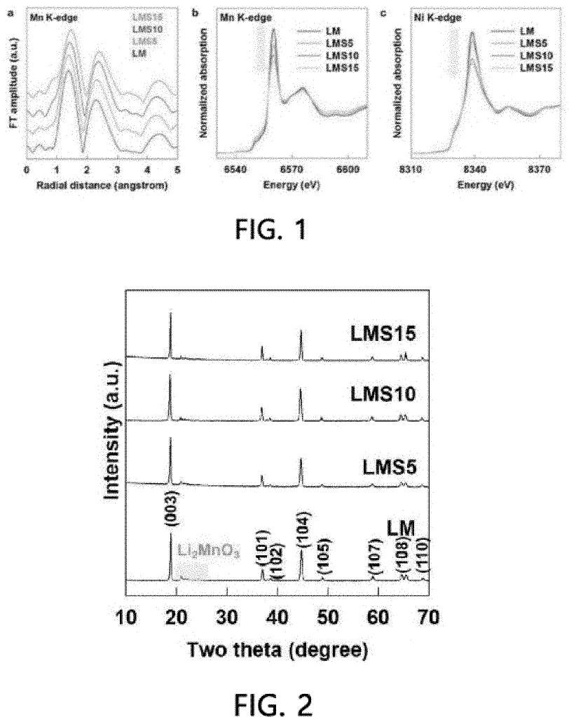

Hereinafter, referring to FIGS. 1 to 5, the lithium-rich secondary battery having high-capacity/high-stability according to the present invention will be described in detail.

The present invention provides a positive electrode active material for a lithium-rich secondary battery, wherein the active material has a surface modified with sulfate.

In general, since a conventional lithium secondary battery has a discharge specific capacity of less than 200 mAh/g, it is difficult to use it as a power source for an electric vehicle or the like. Accordingly, although a lithium-rich secondary battery has been introduced to implement a lithium secondary battery having a high energy density in order to overcome the limitation of reversible capacity, the lithium-rich secondary battery causes an irreversible extraction reaction of oxygen in which the oxygen is excessively oxidized between initial charge and discharge to become a gas, whereby the structure of the active material is collapsed or a voltage drop phenomenon occurs accordingly, resulting in a problem of accelerating deterioration of the secondary battery structure. In addition, there are electrical/chemical problems such as increased resistance and generation of gas due to electrolyte decomposition caused by high voltage driving.

Therefore, the present invention provides a lithium-rich secondary battery, which has high capacity enough to be used as a power source for electric/hybrid vehicles by modifying a surface of a positive electrode active material for the lithium-rich secondary battery with sulfate to suppress the irreversible reaction of oxygen during initial charging and discharging process.

To this end, according to the present invention, the surface of the positive electrode active material for the lithium-rich secondary battery is modified with sulfate so that the content of sulfur (S) is 0.3 to 1.0% by weight (volume) of the total positive electrode active material.

That is, in general, during initial charging of the lithium-rich secondary battery, a phenomenon occurs in which two lithium ions and two electrons are desorbed together with oxygen gas in a high voltage state based on a positive electrode potential.

However, when discharged again, since only one lithium ion and one electron are inserted into the positive electrode, a covalent bond between the transition metal (manganese, cobalt, nickel, etc.) used and oxygen is formed, leading to an irreversible reaction of oxygen. The irreversible reaction of oxygen may collapse the structure of the positive electrode active material or cause a voltage drop phenomenon, thereby greatly degrading the performance of the secondary battery.

However, according to the present invention, by modifying the surface with sulfate, a strong covalent bond between sulfur and oxygen is formed and the covalent bond between the transition metal and oxygen is weakened, suppressing the irreversible reaction of oxygen and inducing a reversible redox reaction of oxygen. Therefore, it is possible to overcome the limitations inherent in the positive electrode active material of the lithium-rich secondary battery.

More specifically, referring to FIG. 1, it can be seen that a bond distance between a first shell meaning the covalent bond of transition metal-oxygen and a second shell meaning the bond between the transition metals is lengthened after the surface modification with sulfate according to the present invention. This means that the surface modification with sulfate according to the present invention reduces the oxidation state of the transition metal and weakens the covalent bond between the transition metal and oxygen, thereby increasing the ionic bond. As a result, it can be seen that the irreversible reaction of oxygen is suppressed and the reversible redox reaction of oxygen is induced.

In order to make longer the bond distance between a first shell meaning the covalent bond of transition metal-oxygen and a second shell meaning the bond between the transition metals after the surface modification with sulfate according to the present invention, the content of sulfur included by the surface modification with sulfate should be 0.3 to 1.0% by weight based on the total weight of the positive electrode active material. More preferably, the sulfur content is 0.4 to 0.9% by weight, and most preferably 0.5 to 0.7% by weight, based on the total weight of the positive electrode active material. If the content of sulfur is less than 0.3%, the sulfur content may be too small to sufficiently modify the surface; and if the sulfur content exceeds 1.0%, the performance of the finally manufactured secondary battery may be deteriorated due to the generation of sulfur impurities.

In addition, the sulfate may be a sulfate used for conventional surface modification in the art as long as it meets the purpose of the present invention, and may preferably be derived from thiourea (NH₂CSNH₂), but is not limited thereto. In this case, thiourea may be more advantageous than sulfuric acid solution or sulfur powder in that the surface may be modified in a single phase without structural deformation of the lithium-rich oxide or impurities.

Meanwhile, conventional lithium-rich oxides exhibit a very large average voltage decrease as they change from a layered structure to a rock salt structure through a spinel structure, as compared to oxides of other layered structures. More specifically, as described above, cation mixing occurs in which the transition metal moves from the surface to the lithium layer during a charging and discharging process, whereby the layered structure is changed into a spinel structure, thereby gradually decreasing a lithiation-delithiation voltage. In addition, when electrochemically activated lithium and oxygen are irreversibly removed, migration of the transition metals into the lithium layer inevitably occurs. At this time, there may be a problem that the structure of the positive electrode active material is collapsed, thereby accelerating the deterioration of the structure of the secondary battery.

Therefore, the present invention can implement a highly stable lithium-rich secondary battery capable of preventing the deterioration in structural stability while realizing a high capacity by stabilizing the irreversible extraction reaction of oxygen as described above.

To this end, the positive electrode active material according to an embodiment of the present invention may be represented by the following chemical formula (1):

LiₐNi_{b}Mn_{c}O_{d}S (1)

wherein a is 1.2 to 1.8, b is 0.2 to 0.3, c is 0.5 to 1.5, and d is 2 to 3.

More specifically, referring to the XRD pattern of FIG. 2, it can be seen that the positive electrode active materials using Li_{1.5}Ni_{0.25}Mn_{0.75}O as a precursor according to an embodiment of the present invention show peaks corresponding to a rhombohedral LiMO₂ structure and a monoclinic Li₂MnO₃ structure even after the surface modification with sulfate; and that the initial precursor structure, Li_{1.5}Ni_{0.25}Mn_{0.75}O, is maintained without phase transition/change or impurity formation even after the surface modification with sulfate.

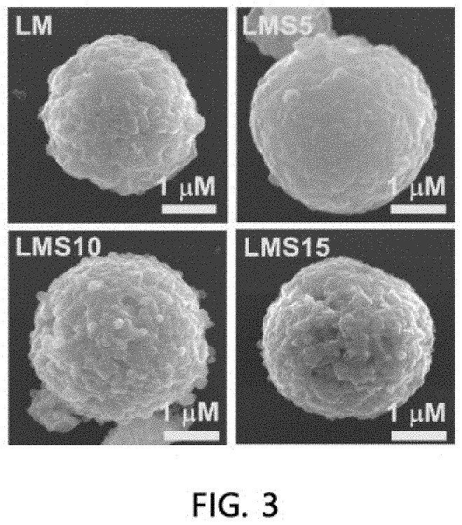

In addition, referring to the SEM image of FIG. 3, it can be seen that the initial precursor structure, Li_{1.5}Ni_{0.25}Mn_{0.75}O, is maintained without the structural/physical deformation even after the surface modification, in view of the fact that the positive electrode active material having the surface modified with sulfate according to the present invention has a spherical shape with a certain diameter but no other shapes of materials observed.

From this, it can be seen that the lithium-rich secondary battery according to the present invention sufficiently maintains structural stability without additionally requiring the chemical composition control or the heterogeneous element substitution.

Meanwhile, in order to simultaneously implement high capacity/high stability of the lithium-rich secondary battery as in the present invention, a method of forming a layered structure of additional materials has been proposed. However, in this case, a problem of structural instability due to the additional layer may occur, and the performance of the lithium-rich secondary battery rapidly decreases due to the large polarization resistance, so that the lithium-rich secondary battery can not be used for high-speed charging and discharging.

Therefore, in order to implement a positive electrode active material for the lithium-rich secondary battery having the above-described high capacity and high stability at the same time without further including an additional layer, the positive electrode active material for the lithium-rich secondary battery according to the present invention may satisfy both the following relational equations (1) and (2):

Mn³⁺/Me=1.0 to 2.2; and (1)

Ni²⁺/Ni³⁺=0.8 to 2.4. (2)

More specifically, referring to FIG. 3, it is confirmed through XPS analysis that the sulfate modifies the surface and exists as SO₄²⁻, and thus, it can be seen that the present invention exhibits structural stability without including an additional layer.

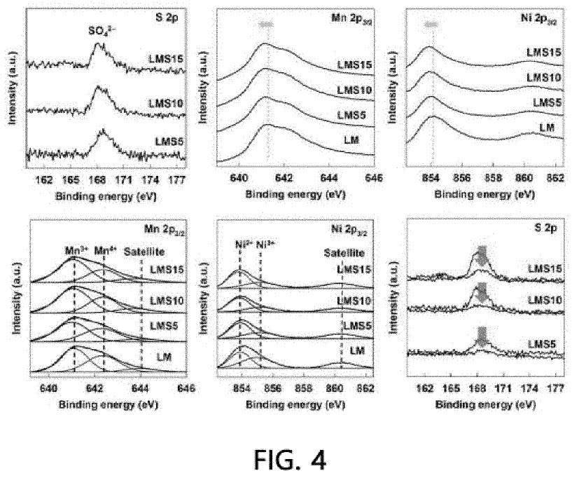

In addition, referring to FIG. 4 and Table 2, it can be seen through XPS analysis of Mn 2p_{3/2}, Ni 2p_{3/2} that Mn and Ni are reduced due to the surface modification with sulfate, and the respective ratios of Mn³⁺/Me and Ni²⁺/Ni³⁺ are increased. From this, not only the above-mentioned high structural stability is exhibited, but also the transition metal-oxygen bond is weakened by the reduction of the transition metal, thereby solving the above-mentioned irreversible problem of oxygen.

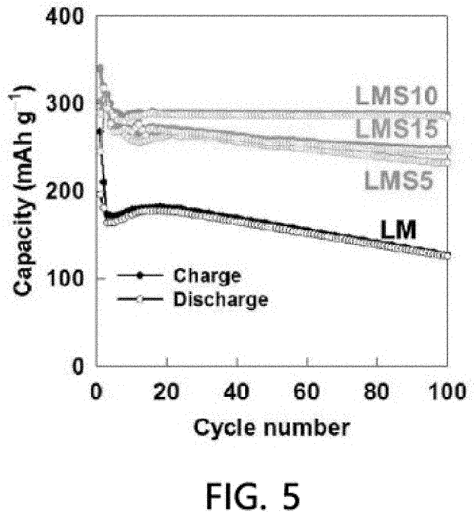

Accordingly, as shown in FIG. 5, the lithium secondary battery including the positive electrode active material for a lithium-rich secondary battery according to the present invention can exhibit a charge/discharge capacity of 220 mAhg⁻¹ or more, more preferably 250 mAhg⁻¹ or more, and most preferably 280 mAhg⁻¹ or more at a voltage of 4.8 V and a current density of 20 mAhg⁻¹.

That is, according to the present invention, as the irreversible reaction of oxygen is suppressed and the reversible reaction of oxygen is induced, it is possible to use the oxidation-reduction of oxygen constituting the oxide together with the redox reaction of the transition metal, whereby the inherent characteristics of the lithium-rich secondary batteries, which exhibit high usable capacity, can be fully utilized to realize secondary batteries with high capacity and greatly improve electrical/chemical/structural stability.

Next, a method for manufacturing the positive electrode active material for a lithium-rich secondary battery according to the present invention will be described. However, in order to avoid duplication, descriptions of parts having the same technical concept as the positive electrode active material for a lithium-rich secondary battery described above will be omitted.

First, the method for manufacturing a positive electrode active material for a lithium-rich secondary battery according to the present invention includes a step of preparing a positive electrode active material comprising lithium manganese nickel oxide (LMNO) whose surface is modified with a sulfur precursor to form sulfate on the surface.

The lithium manganese nickel oxide (LMNO) may be represented by the following chemical formula (1):

LiₐNi_{b}Mn_{c}O_{d}S (1)

In particular, since the present invention relates to a lithium-rich secondary battery having a relatively large content of lithium (L), in Formula (1) above, a may be 1.2 to 1.8, b may be 0.2 to 0.3, c may be 0.5 to 1.5, and d may be 2 to 3.

In addition, the sulfur precursor may be a sulfuric acid solution or sulfur powder, more preferably thiourea (NH₂CSNH₂), which may be more advantageous in that the surface can be modified in a single phase without structural deformation of the lithium-rich oxide or impurities.

As a method of modifying the surface with the sulfur precursor, any conventional surface modification method may be used as long as it meets the purpose of the present invention, and as a non-limiting example thereof, the sulfur precursor may be mixed with the lithium manganese nickel oxide and the solvent, stirred, and heat treated to modify the surface.

Further, the lithium manganese nickel oxide and the sulfur precursor may react in a weight ratio of 1:0.2 to 2.0, and more preferably in a weight ratio of 1:1.0 to 1.8. If the weight ratio of the sulfur precursor to the lithium manganese nickel oxide is less than 0.2, the ratio of the sulfur precursor is so small that the surface modification of the final positive electrode active material does not occur sufficiently, and thus, a desired high-capacity/high-stability lithium-rich secondary battery cannot be manufactured. On the other hand, if the weight ratio of the sulfur precursor to the lithium manganese nickel oxide exceeds 2.0, the content of the sulfur precursor may be excessively high, resulting in the formation of impurities or poor electrical conductivity.

The lithium manganese nickel oxide (LMNO) and the sulfur precursor may react in a weight ratio of 1:0.2 to 2.0 to prepare a positive electrode active material for a lithium-rich secondary battery, wherein the content of sulfur (S) in the positive electrode active material is 0.3 to 1.0 weight (volume) %.

On the other hand, the present invention provides a lithium secondary battery including a positive electrode active material prepared according to the method for manufacturing a positive electrode active material for a lithium-rich secondary battery according to the present invention, whereby the inherent characteristics of the lithium-rich secondary batteries, which exhibit high usable capacity, can be fully utilized to realize secondary batteries with high capacity and greatly improve electrical/chemical/structural stability.

Hereinafter, the present invention will be described in more detail by way of examples, but it should be understood that the following examples are not intended to limit the scope of the present invention, but to aid understanding of the present invention.

### EXAMPLE 1

3.4 g of NiSO₄.6H₂O (Sigma-Aldrich), 6.4 g of MnSO₄.6H₂O (Sigma-Aldrich), and 21.4 g of NaHCO₃ (Sigma-Aldrich) were dissolved in 250 mL of distilled water, stirred for 30 minutes, and then washed with distilled water and ethanol to remove impurities, and dried sufficiently at 50° C. to obtain a powder.

Then, the obtained powder was mixed with 2.88 g of Li₂CO₃ (Sigma-Aldrich) to form pellets and heat-treated at 900° C. for 10 hours to synthesize Li_{1.5}Ni_{0.25}Mn_{0.75}O_{2.5}.

Then, for surface modification with sulfate, 0.25 g of Li_{1.5}Ni_{0.25}Mn_{0.75}O_{2.5} and 0.25 g of NH₂CSNH₂ (Sigma-Aldrich) were put into 50 mL of distilled water, and then stirred for 1 hour. After the stirring was completed, the powder was settled and sufficiently dried in an oven at 50° C., and then heat-treated at 300° C. for 2 hours to obtain a final positive electrode active material for a lithium-rich secondary battery.

### Examples 2 to 6

A positive electrode active material for a lithium-rich secondary battery was prepared in the same manner as in Example 1, except that the type and weight of the sulfate and the weight of the positive electrode active material were changed as shown in Table 1 below.

### Comparative Example 1

A positive electrode active material was prepared in the same manner as in Example 1, except that the surface was not modified with sulfate.

TABLE 1

| | Li_{1.5}Ni_{0.25}Mn_{0.75}O_{2.} | Sulfate precursor | | Weight |
|---|---|---|---|---|
| | Weight (g) | Type | Weight (g) | ratio |
| Example 1 | 0.25 | NH₂CSNH₂ | 0.25 | 1:1 |
| Example 2 | 0.25 | NH₂CSNH₂ | 0.175 | 1:0.7 |
| Example 3 | 0.25 | NH₂CSNH₂ | 0.375 | 1:1.5 |
| Example 4 | 0.25 | NH₂CSNH₂ | 0.02 | 1:0.08 |
| Example 5 | 0.25 | NH₂CSNH₂ | 0.84 | 3.3 |
| Example 6 | 0.25 | S | 0.25 | 1:1 |
| Comparative | 0.25 | — | 0 | 1:0 |
| Example 1 | | | | |

Example 1: designated as LMS 10
Example 2: designated as LMS 5
Example 3: designated as LMS 15
Comparative Example 1: designated as LM

### Experimental Example 1

The positive electrode active materials prepared in the Examples and Comparative Examples were measured using powder X-ray diffraction (XRD) (Rigaku, Ultima IV), and the results are shown in FIG. 2 and Table 2.

### Experimental Example 2

The positive electrode active materials prepared in the Examples and Comparative Examples were measured using a scanning electron microscope image (FE-SEM) (JEOL, JSM-7001F), and the results are shown in FIG. 3.

### Experimental Example 3

The positive electrode active materials prepared in the Examples and Comparative Examples were analyzed using X-ray photoelectron spectroscopy (XPS) (Thermo U.K., K-alpha), and the results are shown in FIG. 4.

### Experimental Example 4

The positive electrode active materials prepared in the Examples and Comparative Examples were subjected to XPS analysis using extended X-ray absorption fine structure (EXAFS) and X-ray absorption near edge structure (XANES), and the results are shown in FIG. 1 and Table 2.

### Experimental Example 5

The positive electrode active materials prepared in the Examples and Comparative Examples were used to prepare a slurry having a ratio of active material: carbon:binder=80:10:10, and the slurry was applied to aluminum foil as a substrate. A lithium secondary battery was manufactured using lithium metal as a negative electrode and a CR2016 coin cell, and electrode activity values of the manufactured secondary battery were measured at a voltage of 4.8 V and a current density of 20 mAhg⁻¹, and the results are shown in FIG. 5.

TABLE 2

| | | | Sulfur | | |
|---|---|---|---|---|---|
| | Lattice parameters | | content | | |
| | a (Å) | c (Å) | (%) | Mn³⁺/Mn⁴⁺ | Ni²⁺/Ni³⁺ |
| Example 1 | 2.859 | 14.254 | 0.57 | 1.85 | 1.87 |
| Example 2 | 2.854 | 14.245 | 0.38 | 1.34 | 1.70 |
| Example 3 | 2.862 | 14.257 | 0.83 | 2.03 | 2.10 |
| Example 4 | 2.851 | 14.200 | 0.01 | 1.13 | 1.08 |
| Example 5 | 2.866 | 14.260 | 1.12 | 2.21 | 2.38 |
| Example 6 | 2.890 | 14.380 | 1.89 | 2.33 | 2.45 |
| Comparative | 2.851 | 14.198 | None | 1.11 | 1.00 |
| Example 1 | | | | | |

Referring to FIG. 1 and Table 2, it can be seen that the bond distance between a first shell meaning the covalent bond of transition metal-oxygen and a second shell meaning the bond between the transition metals is lengthened after the surface modification with sulfate according to the present invention. This means that the surface modification with sulfate according to the present invention reduces the oxidation state of the transition metal and weakens the covalent bond between the transition metal and oxygen, thereby increasing the ionic bond. As a result, it can be seen that the irreversible reaction of oxygen is suppressed and the reversible redox reaction of oxygen is induced.

Referring to the XRD pattern of FIG. 2, it can be seen that the Examples using Li_{1.5}Ni_{0.25}Mn_{0.75}O as a precursor according to an embodiment of the present invention show peaks corresponding to a rhombohedral LiMO₂ structure and a monoclinic Li₂MnO₃ structure even after the surface modification with sulfate; and that the initial precursor structure, Li_{1.5}Ni_{0.25}Mn_{0.75}O, is maintained without phase transition/change or impurity formation even after the surface modification with sulfate.

Next, referring to FIG. 3, it can be seen that the initial precursor structure, Li_{1.5}Ni_{0.25}Mn_{0.75}O, is maintained without the structural/physical deformation even after the surface modification, in view of the fact that the Examples having the surface modified with sulfate according to the present invention has a spherical shape with a certain diameter but no other shapes of materials observed.

Next, referring to FIG. 4, it can be seen through XPS analysis of Mn 2p_{3/2}, Ni 2p_{3/2} that Mn and Ni are reduced due to the surface modification with sulfate, and the respective ratios of Mn³⁺/Mn⁴⁺ and Ni²⁺/Ni³⁺ are increased. From this, not only the above-mentioned high structural stability is exhibited, but also the transition metal-oxygen bond is weakened by the reduction of the transition metal, thereby solving the above-mentioned irreversible problem of oxygen.

Next, referring to FIG. 5, it can be seen that the Examples according to the present invention showed a charge/discharge capacity of 220 mAhg⁻¹ or more at a voltage of 4.8 V and a current density of 20 mAhg⁻¹, but Comparative Example 1 showed a charge/discharge capacity of 220 mAhg⁻¹ or less. Meanwhile, Example 1, which is the best example, can exhibit a charge/discharge capacity of 280 mAhg⁻¹ or more at the same voltage and current density.

As described above, according to the present invention, as the irreversible reaction of oxygen is suppressed and the reversible reaction of oxygen is induced, it is possible to use the oxidation-reduction of oxygen constituting the oxide together with the redox reaction of the transition metal, whereby the inherent characteristics of the lithium-rich secondary batteries, which exhibit high usable capacity, can be fully utilized to realize secondary batteries with high capacity and greatly improve electrical/chemical/structural stability.

1. A positive electrode active material for a lithium-rich secondary battery, the active material having a surface modified with sulfate and thus having a sulfur (S) content of 0.3 to 1.0% by weight.

2. The positive electrode active material for a lithium-rich secondary battery according to claim 1, wherein the positive electrode active material does not further include an additional layer.

3. The positive electrode active material for a lithium-rich secondary battery according to claim 1, wherein the positive electrode active material is represented by the following chemical formula (1):
LiₐNi_{b}Mn_{c}O_{d}S (1)
wherein a is 1.2 to 1.8, b is 0.2 to 0.3, c is 0.5 to 1.5, and d is 2 to 3.

4. The positive electrode active material for a lithium-rich secondary battery according to claim 1, wherein the positive electrode active material satisfies both the following relational equations (1) and (2):
Mn³⁺/Mn⁴⁺=1.0 to 2.2; and (1)
Ni²⁺/Ni³⁺=0.8 to 2.4. (2)

5. The positive electrode active material for a lithium-rich secondary battery according to claim 1, wherein the sulfate is derived from thiourea (NH₂CSNH₂).

6. The positive electrode active material for a lithium-rich secondary battery according to claim 1, wherein the positive electrode active material has a charge/discharge capacity of 220 mAhg⁻¹ or more at a voltage of 4.8 V and a current density of 20 mAhg⁻¹.

7. A method of producing a positive electrode active material for a lithium-rich secondary battery, the method including:
a step of preparing a positive electrode active material comprising lithium manganese nickel oxide (LMNO) whose surface is modified with a sulfur precursor to form sulfate on the surface.
wherein the content of sulfur (S) in the positive electrode active material is 0.3 to 1.0 weight (volume) %.

8. The method of producing a positive electrode active material for a lithium-rich secondary battery according to claim 6, wherein the sulfur precursor is thiourea (NH₂CSNH₂).

9. The method of producing a positive electrode active material for a lithium-rich secondary battery according to claim 6, wherein the lithium manganese nickel oxide (LMNO) and the sulfur precursor react in a weight ratio of 1:0.2 to 2.0.

10. A lithium secondary battery comprising the positive electrode active material according to claim 1.
